(19) United States
(12) Patent Application Publication
(10) Pub. No.: US 2007/0146827 A1
(43) Pub. Date: Jun. 28, 2007

(54) Image printing apparatus, method of manufacturing the same, accessory device for image printing apparatus, and method of manufacturing the same

(76) Inventor: Akihiko Kakita, Tokyo (JP)

Correspondence Address: CANTOR COLBURN, LLP, 55 GRIFFIN ROAD SOUTH, BLOOMFIELD, CT, 06002, US

(21) Appl. No.: 11/516,844

(22) Filed: Sep. 7, 2006

(30) Foreign Application Priority Data
Dec. 28, 2005 (JP) 2005-377174

(51) Int. Cl. G06K 15/00

(52) U.S. Cl. 358/498; 358/1.16

(57) ABSTRACT

The present invention provides a method of manufacturing an image printing apparatus, which comprises, in order to manufacture a specific type of image printing apparatus, the steps of preparing an accessory device main body that is common among a plurality of types of image printing apparatuses; forming a duct forming member which has at least one of a suction port and an exhaust port and specifically matches the specific type of image printing apparatus regarding at least one of shape, position, and number; connecting the duct forming member to the common accessory device main body to form an accessory device; and connecting the accessory device to the image printing apparatus main body. The present invention further provides an image printing apparatus and an accessory device which are manufactured by the manufacturing method.

### CROSS-REFERENCE TO RELATED APPLICATION

This application makes reference to, incorporates the same herein, and claims all benefits accruing under 35 U.S.C. §119 from an application for “IMAGE PRINTING APPARATUS, METHOD OF MANUFACTURING THE SAME, ACCESSORY DEVICE FOR IMAGE PRINTING APPARATUS, AND METHOD OF MANUFACTURING THE SAME” earlier filed in the Japanese Patent Office on Dec. 28, 2005, and there duly assigned the application No. 2005-377174.

### BACKGROUND OF THE INVENTION

1. Field of the Invention

The present invention relates to an image printing apparatus in which an image printing apparatus main body which prints an image on a printing medium such as a paper sheet or an OHP sheet is connected to an accessory device such as a feed device, post-processing device, or heat or vapor suction/exhaust device.

2. Description of Related Art

In case of taking an image printing apparatus which prints an image with an electrophotographic process as an example, a fixing portion or developing portion generates heat, so the apparatus is provided with a suction/exhaust device in order to discharge the heat. An ozone generation source and toner scattering source exist in the image printing apparatus employing the electrophotographic process. Hence, the image printing apparatus is provided with an exhaust device which exhausts after the ozone is removed, and an exhaust device which exhausts after the toner is removed.

An image printing apparatus which prints an image with an image printing process other than the electrophotographic process is also provided with a suction/exhaust device to discharge heat or vapor.

An image printing apparatus has been popular in which an image printing apparatus main body is connected to an accessory device such as a feed device which feeds an image printing medium to the image printing apparatus or a post-processing device which post-processes an image-printed printing medium, so that the performance and function improve.

Regarding the suction/exhaust system in such an image printing apparatus, a technique is developed which allows air to flow between the image printing apparatus main body and the accessory device to improve the cooling effect and to achieve downsizing.

For example, Japanese Patent Laid-Open No. 9-114158 (patent document 1) discloses an image printing apparatus in which air from the cooling fan of an image printing apparatus main body is introduced into an accessory device and is exhausted outside from the accessory device.

Japanese Patent Laid-Open No. 11-119495 (patent document 2) discloses an image printing apparatus which is provided with a switching means for allowing air to flow from an image printing apparatus main body to an accessory device when the accessory device is connected to the image printing apparatus main body.

Japanese Patent Laid-Open No. 2000-352907 (patent document 3) discloses an image printing apparatus with an option that has an opening to introduce air from an image printing apparatus main body and an opening which introduces air to the image printing apparatus main body.

Japanese Patent Laid-Open No. 2003-152924 (patent document 4) discloses an arrangement in which the attaching surfaces of an image printing apparatus and image reading apparatus have openings that match with each other to cool the interior of the image reading apparatus with cooling wind in the image printing apparatus.

Examples of the accessory device to be connected to the image printing apparatus main body include a feed device which feeds a printing medium to the image printing apparatus main body and a post-processing device which post-processes the printing medium on which an image is printed by the image printing apparatus main body. Many of the accessory devices can be commonly used by different types of image printing apparatus main bodies that are different in performance, image printing speed, and the like. Accordingly, often, accessory devices that are common among a plurality of types of image printing apparatus main bodies are employed.

In view of this, in the arrangements as in the image printing apparatuses disclosed in patent documents 1 to 4 in which air flows between the image printing apparatus main body and the accessory device, the image printing apparatus main bodies are of different types and different models. These image printing apparatuses cannot employ the same accessory device even if it can be employed commonly in terms of function and performance. An accessory device that is specifically designed and manufactured for the individual image printing apparatus main body must be employed.

This increases the manufacturing cost of the image printing apparatus, prolongs the development time period, and delays development of the image printing apparatus.

### SUMMARY OF THE INVENTION

The present invention has been made in view of the situation described above, and can decrease the manufacturing cost and shorten the development time period of an image printing apparatus comprising an image printing apparatus main body which prints an image on a printing medium, and an accessory device.

According to the first main aspect of the present invention, there is provided a method of manufacturing an image printing apparatus, comprising, in order to manufacture a specific type of image printing apparatus, the steps of preparing an accessory device main body that is common among a plurality of types of image printing apparatuses, forming a duct forming member which has at least one of a suction port and an exhaust port and specifically matches the specific type of image printing apparatus regarding at least one of shape, position, and number, connecting the duct forming member to the common accessory device main body to form an accessory device, and connecting the accessory device to the image printing apparatus main body.

According to the second main aspect of the present invention, there is provided a method of manufacturing an accessory device for an image printing apparatus, comprising, in order to manufacture different types of accessory devices, the step of mounting a duct forming member which has at least one of a suction port and an exhaust port that are different in at least one of shape, position, and number to an accessory device main body which is common except for the duct forming member.

According to the third and fourth main aspects of the present invention, there is provided an image printing apparatus and an accessory device for an image printing apparatus main body which are respectively manufactured by manufacturing methods according to the first and second main aspects described above.

The present invention is more specifically described in the following paragraphs by reference to the drawings attached only by way of example.

### BRIEF DESCRIPTION OF THE DRAWINGS

A more complete appreciation of the present invention, and many other attendant features and advantages thereof, will become readily apparent as the same becomes better understood by reference to the following detailed description when considered in conjunction with the accompanying drawings in which like reference symbols and like reference numerals indicate the same or similar components, wherein:

FIG. 1 is a schematic view showing the outer appearance of an image printing apparatus according to an embodiment of the present invention;

FIG. 2 is a sectional view showing the schematic arrangement of a color image printing apparatus serving as an image printing apparatus main body which forms the image printing apparatus according to the embodiment of the present invention shown in FIG. 1;

FIG. 3 is a schematic view showing a large quantity feed device according to the embodiment of the present invention shown in FIG. 1;

FIG. 4 is a schematic view showing a suction/exhaust system in the image printing apparatus main body;

FIG. 5 is a schematic view showing a suction/exhaust system in the large quantity feed device;

FIG. 6 is a perspective view showing the outer apparatus of the right side surface of the image printing apparatus main body;

FIG. 7 is a perspective view showing a duct forming member of the large quantity feed device;

FIG. 8 is a schematic view showing a large quantity feed device according to an embodiment of the present invention; and

FIG. 9 is a sectional view showing a fixing mechanism which connects the large quantity feed device to the image printing apparatus main body.

### DETAILED DESCRIPTION OF THE PREFERRED EMBODIMENT

Some preferred embodiments of the present invention will now be described below in detail with reference to the accompanying drawings. Note that the present invention is not limited to these embodiments.

An image printing apparatus according to the present invention comprises an image printing apparatus main body which prints an image on a printing medium, and an accessory device.

Examples of the accessory device include a feed device which feeds the printing medium to the image printing apparatus main body, and a post-processing device which performs a post-process such as perforation, folding, stapling, and bookbinding for the printing medium on which an image has been printed by the image printing apparatus main body.

The embodiment shown in the attached drawing is an image printing apparatus comprising an image printing apparatus main body 100 and a large quantity feed device 200 serving as an accessory device which feeds a printing medium to the image printing apparatus main body 100.

### <Image Printing Apparatus Main Body>

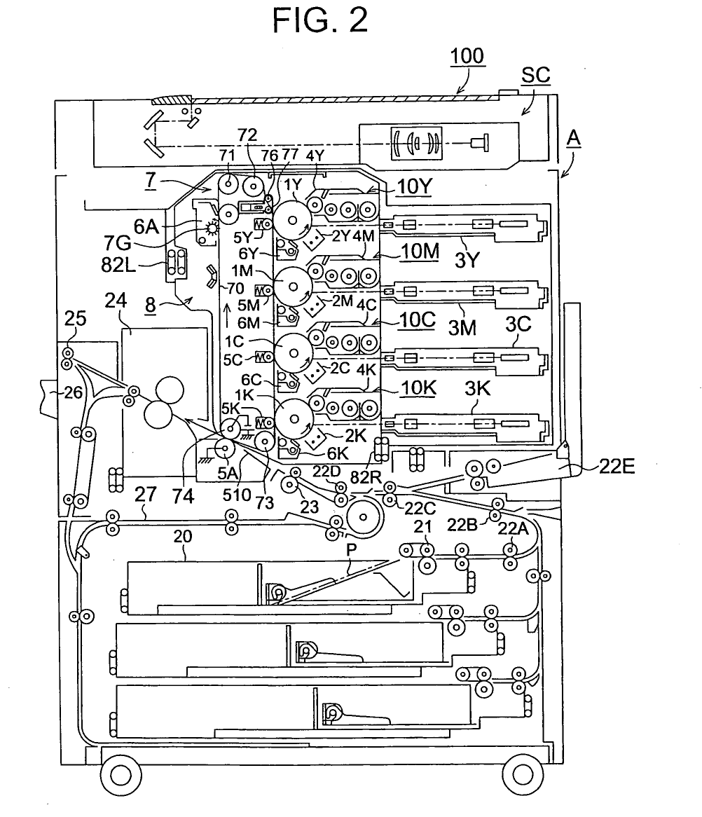

FIG. 2 is a view showing the schematic arrangement of a color image printing apparatus serving as an image printing apparatus main body which forms the image printing apparatus according to the embodiment of the present invention.

The image printing apparatus main body 100 is a tandem type full-color image printing apparatus, and comprises a plurality of sets of image forming units 10Y, 10M, 10C, and 10K, an endless-belt-like intermediate transfer body unit 7 serving as a unit for an intermediate transfer body, a feed/convey portion 21, and a fixing unit 24. A document image reading device SC is arranged on an image printing unit A of the image printing apparatus main body 100.

A housing 8 which can be pulled out through support rails 82L and 82R is arranged in the image printing unit A. The image forming units 10Y, 10M, 10C, and 10K and endless-belt-like intermediate transfer body unit 7 are arranged in the housing 8. The housing 8 can be one called a process cartridge which is used as an exchangeable member that can be separated from the image printing unit A.

Referring to FIG. 2, the image forming units 10Y, 10M, 10C, and 10K are arranged in tandem with each other in the vertical direction. The endless-belt-like intermediate transfer body unit 7 is arranged on the left side of photosensitive drums which form the respective image forming units. The endless-belt-like intermediate transfer body unit 7 comprises an endless-belt-like intermediate transfer body 70 wound around rollers 71, 72, 73, 74, 76, and 77, primary transfer rollers 5Y, 5M, 5C, and 5K which transfer the toner images formed by the respective image forming units onto the intermediate transfer body 70, and a cleaning means 6A which removes toner remaining on the intermediate transfer body 70. Image printing performed by the image printing apparatus main body 100 will be described.

The image forming unit 10Y which forms a yellow image has a photosensitive drum 1Y, and a charging device 2Y, exposing device 3Y, developing device 4Y, primary transfer roller 5Y, and cleaning means 6Y which are arranged around the photosensitive drum 1Y. The primary transfer roller 5Y serves as a primary transfer means. The image forming unit 10M which forms a magenta image has a photosensitive drum 1M, and a charging device 2M, exposing device 3M, developing device 4M, primary transfer roller 5M, and cleaning means 6M which are arranged around the photosensitive drum 1M. The primary transfer roller 5M serves as a primary transfer means. The image forming unit 10C which forms a cyan image has a photosensitive drum 1C, and a charging device 2C, exposing device 3C, developing device 4C, primary transfer roller 5C, and cleaning means 6C which are arranged around the photosensitive drum 1C. The primary transfer roller 5C serves as a primary transfer means. The image forming unit 10K which forms a black image has a photosensitive drum 1K, and a charging device 2K, exposing device 3K developing device 4K, primary transfer roller 5K, and cleaning means 6K which are arranged around the photosensitive drum 1K. The primary transfer roller 5K serves as a primary transfer means.

The endless-belt-like intermediate transfer body unit 7 serving as the intermediate transfer body unit has the semiconductive endless-belt-like intermediate transfer body 70 which is wound around and pivotally supported by the plurality of rollers.

Single-color toner images formed by the image forming units 10Y, 10M, 10C, and 10K are sequentially transferred onto the pivoting intermediate transfer body 70 by the primary transfer rollers 5Y, 5M, 5C, and 5K to form a composite toner image.

Printing media P such as paper sheets stored in a feed cassette 20 are fed out by the first feed rollers 21 one by one. Each printing medium P is then conveyed by feed rollers 22A, 22B, 22C, and 22D and stops temporarily at a position upstream of registration rollers 23. After the temporary stop, the printing medium P is conveyed to a transfer position by the registration rollers 23 in synchronism with image formation of the image forming units 10Y, 10M, 10C, and 10K. At the transfer position formed by a transfer roller 5A and the roller 74 which supports the intermediate transfer body 70, a color toner image is transferred onto the printing medium P.

Reference numeral 22E denotes a manual feed portion.

The printing medium P on which the color toner image has been transferred is fixed by the fixing unit 24 and clamped by delivery rollers 25 so as to be placed on a delivery tray 26 outside the image printing apparatus.

In double-sided image printing, after the printing medium P with the image formed on its obverse surface passes through the fixing unit 24, it travels downward, is turned over on a reversal convey path 27, and is fed again to the registration rollers 23. An image is printed on the reverse surface of the re-fed printing medium P and fixed. Then, the printing medium P is delivered to the delivery tray 26.

After the transfer roller 5A serving as a secondary transfer means transfers the color toner image onto the printing medium P, the printing medium P is separated from the intermediate transfer body 70. The toner remaining on the intermediate transfer body 70 is removed by the cleaning means 6A.

### Large Quantity Feed Device 200:

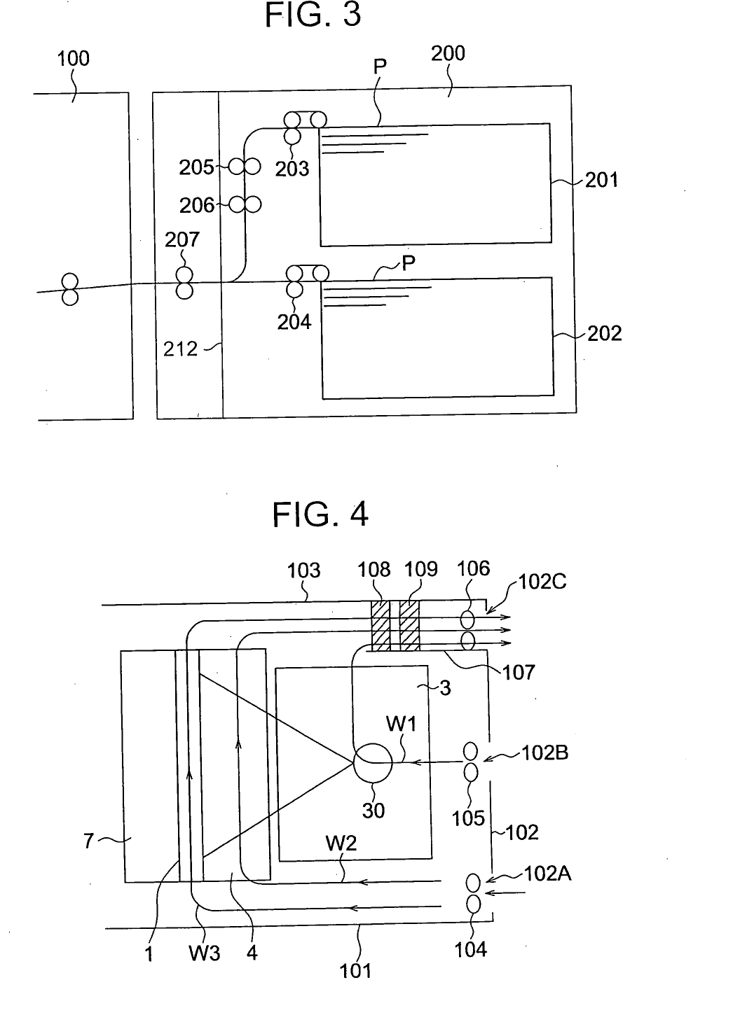

As shown in FIG. 3, the large quantity feed device 200 has upper and lower feed units 201 and 202 in each of which approximately 5,000 printing media P can be stacked. The printing medium P from the upper feed unit 201 is fed out by feed rollers 203 and conveyed by convey rollers 205, 206, and 207 so as to be supplied to the image printing apparatus main body 100. The printing medium P from the lower feed unit 202 is fed out by feed rollers 204 and conveyed by the convey rollers 207 substantially in the horizontal direction so as to be supplied to the image printing apparatus main body 100. The large quantity feed device 200 can be connected to the image printing apparatus main body 100 by removing the manual feed portion 22E from the image printing apparatus main body 100. The manual feed path of the image printing apparatus main body 100 is used as a feed path to be connected to the large quantity feed device 200.

### Suction/Exhaust System:

In the image printing apparatus main body 100, the heat source of the fixing unit 24, the document illumination light source of the reading device, the polygon motors for light reflection of the exposing devices 3Y, 3M, 3C, and 3K, the developing devices 4Y, 4M, 4C, and 4K, and the like generate heat. Also, the charging devices 2Y, 2M, 2C, and 2K, and the like generate ozone. In order to cool the interior of the apparatus and remove the ozone, a suction/exhaust system which introduces external air into the apparatus and exhausts air in the apparatus to the outside is built into the image printing apparatus main body 100.

Depending on the type of the accessory device to be connected to the image printing apparatus main body 100, heat or vapor of a volatile material may be generated in the accessory device. A suction/exhaust system is built into such an accessory device.

In the image printing apparatus main body 100 or the accessory device, the external air is directly introduced into and directly exhausted from the image printing apparatus main body. Also, the external air is introduced into and exhausted from the image printing apparatus main body through the accessory device.

Similarly, external air is taken in and exhausted from the accessory device directly, and through the image printing apparatus main body 100.

As is clearly understood from the embodiment shown in the accompanying drawings, air is directly taken in and exhausted from the image printing apparatus main body 100. Also, the external air is introduced into and exhausted from the image printing apparatus main body 100 through the large quantity feed device 200. In the embodiment shown in the accompanying drawings, moisture condensation prevention of removing water vapor generated in the large quantity feed device 200 is performed.

FIG. 4 shows the suction/exhaust system which cools the exposing device and developing device of the image printing apparatus main body 100 and removes ozone and scattered toner.

The suction/exhaust system shown in FIG. 4 is provided to each of the image forming units 10Y, 10M, 10C, and 10K. In FIG. 4, letters Y, M, C, and K are omitted so, e.g., each of the photosensitive drums 1Y, 1M, 1C, and 1K is expressed as the photosensitive drum 1.

The image printing apparatus main body 100 has a casing portion 101 which forms a front panel, a casing portion 102 which forms a side panel serving as a side frame on a side opposing the large quantity feed device 200, and a casing portion 103 which forms a rear panel. External air is introduced into the image printing apparatus main body 100 from suction ports 102A and 102B formed in the casing portion 102. Air then flows through flow channels indicated by reference numerals W1, W2, and W3 and is discharged from an exhaust port 102C formed in the casing portion 102 to outside the image printing apparatus main body 100.

Air flowing through the flow channel W1 mainly cools a polygon motor 30 of the exposing device 3. Air flowing through the flow channel W2 mainly cools the developing device 4 and removes scattered toner near the developing device 4. Air flowing through the flow channel W3 mainly removes ozone generated by the charging device (indicated as 2Y, 2M, 2C, and 2K in FIG. 2).

The suction ports 102A and 102B and the exhaust port 102C are respectively provided with fans 104, 105, and 106 serving as blowing device to take in and exhaust air.

An electrostatic filter 108 which removes the toner and an ozone filter 109 which removes the ozone are arranged in a duct 107 which guides air to the exhaust port 102C.

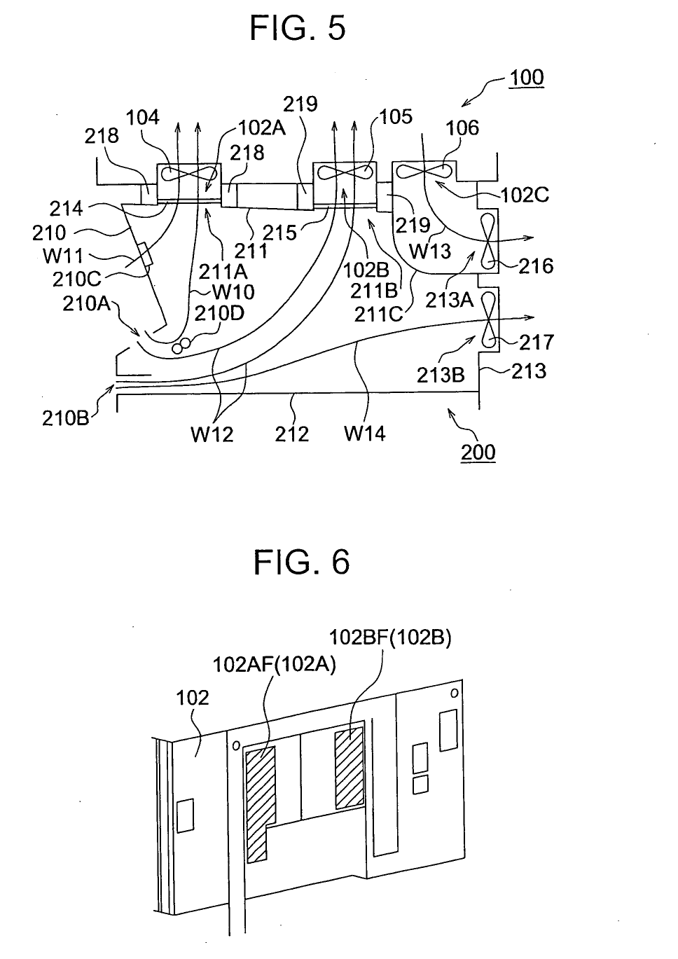

FIG. 5 shows a suction/exhaust system in the large quantity feed device.

The large quantity feed device 200 has a front casing portion 210, a rear casing portion 213, a duct forming member 211 which opposes the image printing apparatus main body 100, a casing portion (not shown in FIG. 5) on a side surface opposite to the duct forming member 211, and a partition wall 212 which separates a feed unit region and the suction/exhaust system. The casing portion 210 forms a front panel which is openable/closeable about a shaft 210D as the center.

The duct forming member 211 is arranged on the side surface of the large quantity feed device 200 on a side which opposes the image printing apparatus main body 100, and has an exhaust port which forms an air flow from the large quantity feed device 200 to the image printing apparatus main body 100 and a suction port which forms an air flow from the image printing apparatus main body 100 to the large quantity feed device 200. Alternatively, the duct forming member 211 can be formed to have a duct that forms a bidirectional air flow, or a duct that forms a unidirectional air flow.

The casing portion 210 has a suction port 210A, the duct forming member 211 has exhaust ports 211A and 211B, and the casing portion 213 has exhaust ports 213A and 213B. The gap between the casing portion 210 and partition wall 212 forms a suction port 210B.

The exhaust port 211A mates with the suction port 102A of the image printing apparatus main body 100, and the exhaust port 211B mates with the suction port 102B of the image printing apparatus main body 100. Air exhausted from the exhaust port 102C of the image printing apparatus main body 100 is discharged through the exhaust port 213A. Furthermore, a hand insertion port 210C in an opening/closing handle provided to the casing portion 210 also forms a suction port.

Air flow channels W10, W11, W12, W13, and W14 extending from the suction port 210A to the exhaust port 211A, from the insertion port 210C to the exhaust port 211A, from the suction ports 210A and 210B to the exhaust port 211B, from the exhaust port 102C of the image printing apparatus main body 100 to the exhaust port 213A, and from the suction port 210B to the exhaust port 213B, respectively, are formed in the large quantity feed device 200. A curved extended portion 211C of the duct forming member 211 is a duct that guides air exhausted from the exhaust port 102C of the image printing apparatus main body 100 to the exhaust port 213A of the large quantity feed device 200, and forms the flow channel W13.

The flow channels W10 and W11 communicate with the flow channels W2 and W3 in the image printing apparatus main body 100, and the flow channel W12 communicates with the flow channel W1 in the image printing apparatus main body 100. The flow channels W1 to W3 in the image printing apparatus main body 100 communicate with the flow channel W13.

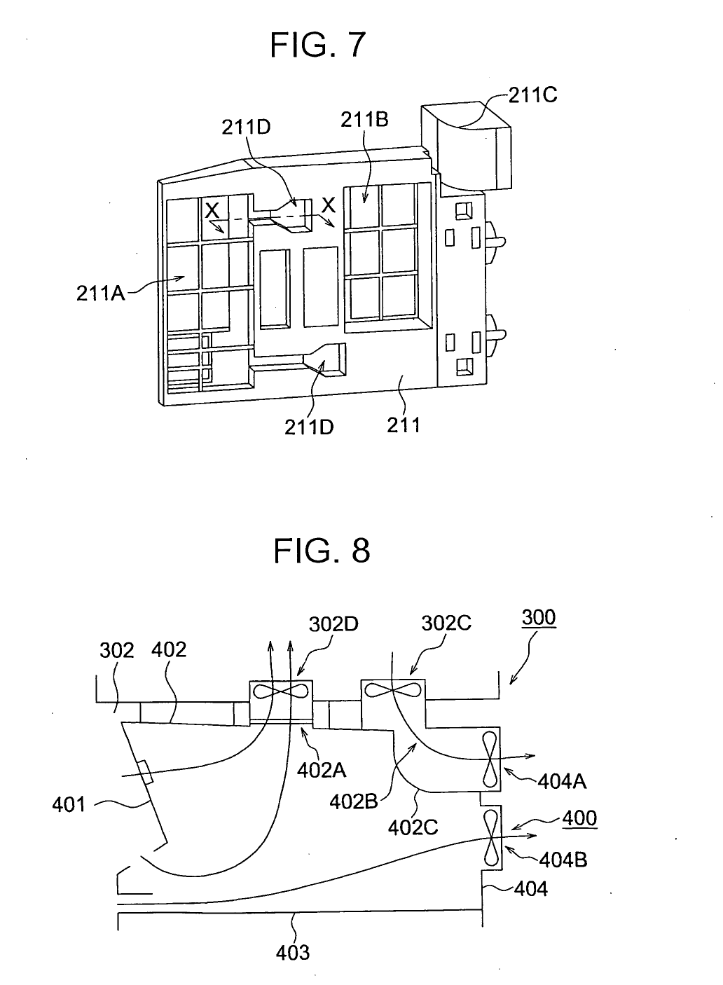

FIG. 6 is a view showing the appearance of the right side surface of the image printing apparatus main body 100, and FIG. 7 is a perspective view of the duct forming member 211 of the large quantity feed device 200.

The suction port 102A formed in the casing portion 102 of the image printing apparatus main body 100 and the exhaust port 211A formed in the duct forming member 211 of the large quantity feed device 200 have shapes to mate with each other. The suction port 102B formed in the casing portion 102 of the image printing apparatus main body 100 and the exhaust port 211B formed in the duct forming member 211 of the large quantity feed device 200 have shapes to mate with each other.

The image printing apparatus main body 100 need not be always connected to the large quantity feed device 200 but can be used alone as an image printing apparatus. When the image printing apparatus main body 100 is to be used alone in this manner, external air is directly introduced into it through the suction ports 102A and 102B. Filters 102AF and 102BF are respectively arranged in the suction ports 102A and 102B.

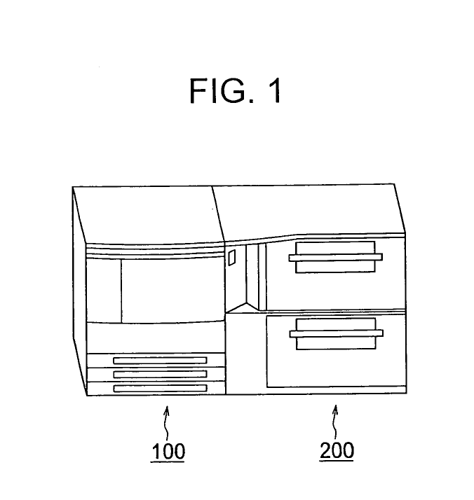

Therefore, the filters 102AF and 102BF of the image printing apparatus shown in FIG. 6 replace filters 214 and 215 of the image printing apparatus shown in FIGS. 1 and 5, that is, the image printing apparatus in which the image printing apparatus main body 100 is connected to the large quantity feed device 200, and are arranged in the duct forming member 211 of the large quantity feed device 200.

Although not shown, a heater which raises the temperature in the apparatus is arranged in the large quantity feed device 200 in order to prevent moisture condensation on the printing media P stacked in the feed units 201 and 202. Air flowing through the flow channel W14 discharges heat used for prevention of moisture condensation.

Reference numeral 214 denotes the filter arranged in the exhaust port 211A; and 215, the filter arranged in the exhaust port 211B. Reference numeral 216 denotes a fan serving as a blowing device arranged in the exhaust port 213A; and 217, a fan serving as a blowing device arranged in the exhaust port 213B.

Reference numeral 218 denotes a filler which seals the gap between the exhaust port 211A of the large quantity feed device 200 side and the suction port 102A of the image printing apparatus main body 100; and 219, a filler which seals the gap between the exhaust port 211B of the large quantity feed device 200 side and the suction port 102B of the image printing apparatus main body 100.

As is apparent from FIGS. 4 and 5, in the suction/exhaust system of the entire image printing apparatus main body, external air introduced through the suction ports 210A, 210B, and 210C of the large quantity feed device 200 flows through the flow channels W10 and W11 and then through the flow channels W2 and W3 in the image printing apparatus main body 100 to cool the developing device 4 and remove the scattered toner and ozone. The air then flows through the flow channel W13 and is exhausted to the outside of the large quantity feed device 200 through the exhaust port 213A. External air introduced through the suction ports 210A and 210B of the large quantity feed device 200 flows through the flow channel W12 and then through the flow channel W1 in the image printing apparatus main body 100 to cool the polygon motor 30. The air then flows through the flow channel W13 and is exhausted outside through the exhaust port 213A of the large quantity feed device 200. External air introduced from the suction port 210B cools the interior of the large quantity feed device 200 and is then exhausted outside through the exhaust port 213B.

The image printing apparatus main body 100 is not only connected to one model of image printing apparatus main body but can be connected to several different models of image printing apparatus main bodies. The image printing apparatus main bodies may be different in the position, shape, and number of the suction port and exhaust port according to the model or type.

The accessory device is formed such that even when the suction port and exhaust port are different among the image printing apparatus main bodies, the accessory device can be connected to any image printing apparatus main body only by forming a duct forming member that matches specifically the type of the image printing apparatus main body without changing the frame or internal structure of the accessory device which is to be connected to the image printing apparatus main body.

FIG. 8 shows a large quantity feed device 400. Only a duct forming member which forms a side surface to be connected to an image printing apparatus main body is formed to match a specific model or type of image printing apparatus main body. Thus, the suction ports of the large quantity feed device 400 are different from those shown in FIGS. 3 and 4.

An image printing apparatus main body 300 comprises a casing portion 302 which has one suction port 302D and one exhaust port 302C and forms a side surface opposing the large quantity feed device 400. The large quantity feed device 400 comprises a casing portion 401 which forms a front panel, a duct forming member 402 which forms a side panel opposing the image printing apparatus main body 300, a partition wall 403 which separates a feed unit region and the image printing apparatus main body 300, and a casing portion 404 which forms a rear panel. As shown in FIG. 8, an exhaust port 402A and suction port 402B are formed in the duct forming member 402 of the large quantity feed device 400 to oppose the suction port 302D and exhaust port 302C of the image printing apparatus main body 300. The suction port 402B is formed by an extended portion 402C of the duct forming member 402. As shown in FIG. 8, the position of the exhaust port 302C of the image printing apparatus main body 300 is different from its equivalent in FIG. 5. Accordingly, the extended portion 402C in FIG. 8 is formed longer than the extended portion 211C in FIG. 5. The casing portions 401 and 402 are identical with the casing portions 210 and 213, respectively, in FIG. 5. The partition wall 403 is identical with the partition wall 212. The casing portion 404 has exhaust ports 404A and 404B.

In the large quantity feed device 200, the duct forming member 211 serving as an accessory device side panel which forms a side surface opposing the image printing apparatus main body 100 is fixed to the image printing apparatus main body 100, so as to connect the large quantity feed device 200 to the image printing apparatus main body 100. This connection is performed using a fixing mechanism provided to the large quantity feed device 200.

With the large quantity feed device 200, an operation space necessary for fixing it is limited. According to the present invention, the large quantity feed device 200 can be fixed even with a limited narrow space, as will be described hereinafter.

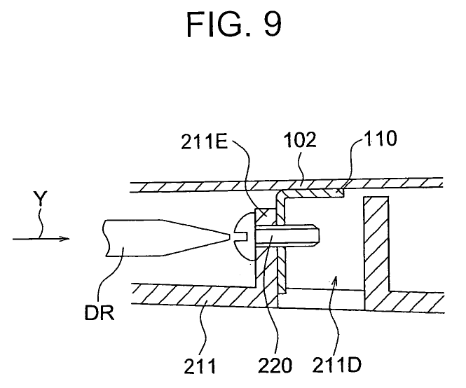

FIG. 9 shows a fixing mechanism which connects the large quantity feed device 200 to the image printing apparatus main body 100. FIG. 9 is a sectional view taken along the line X-X of the duct forming member 211 of FIG. 7.

An opening 211D is formed in the duct forming member 211 serving as the accessory device side panel. An L-shaped metal fixture 110 fixed to the casing portion 102 serving as the main body side panel of the image printing apparatus main body 100 extends through the opening 211D. The metal fixture 110 forms a projection perpendicularly standing substantially at a right angle from the plate surface of the casing portion 102. A wall 211E which forms the opening 211D is abutted against the metal fixture 110 so that a screw hole formed in the metal fixture 110 mates with a through hole formed in the wall 211E. After that, a screw 220 is inserted in the screw hole and fastened with a driver DR. Thus, the casing portion 102 of the image printing apparatus main body 100 is fixed to the duct forming member 211 of the large quantity feed device 200, so the large quantity feed device 200 is connected to the image printing apparatus main body 100.

An inserting direction Y of the driver DR is substantially parallel to the plate surface of the duct forming member 211. The metal fixture 110 is provided to the casing portion 102 to stand perpendicularly from the plate surface of the casing portion 102 substantially at a right angle. The wall 211E is provided to the duct forming member 211 to stand perpendicularly from the plate surface of the duct forming member 211 substantially at a right angle. The metal fixture 110 is fixed to the wall 211E, so that the large quantity feed device 200 can be connected to the image printing apparatus main body 100. Thus, the fixing operation can be performed by inserting a fixing tool such as the driver DR in a limited narrow space.

According to these preferred embodiments, portions other than the duct forming member are made common, and only the duct forming member is formed to correspond to the type and model of each image printing apparatus main body. Even if the type changes regarding cooling of the interior of the apparatus or removal of the ozone, no problem arises, and various types of image printing apparatuses having various types of image printing apparatus main bodies can be manufactured. Thus, the manufacturing cost can be reduced, and the developing speed of the image printing apparatus can be increased.

What is claimed is:

1. A method of manufacturing an image printing apparatus, comprising, in order to manufacture a specific type of image printing apparatus, the steps of:
preparing an accessory device main body that is common among a plurality of types of image printing apparatuses;
forming a duct forming member which has at least one of a suction port and an exhaust port and specifically matches the specific type of image printing apparatus regarding at least one of shape, position, and number;
connecting the duct forming member to the common accessory device main body to form an accessory device; and
connecting the accessory device to the image printing apparatus main body.

2. The method of claim 1, wherein the duct forming member forms a side surface of the accessory device which opposes the image printing apparatus main body, and the image printing apparatus main body and the accessory device have a suction port and an exhaust port that communicate with each other.

3. The method of claim 1, wherein the image printing apparatus main body and the accessory device comprise blowing device.

4. The method of claim 1, wherein the accessory device comprises a casing portion which has at least either one of a suction port through which external air is introduced into the accessory device and an exhaust port through which air is exhausted outside from the accessory device.

5. The method of claim 4, wherein the casing portion is common among the plurality of types of image printing apparatus main bodies.

6. The method of claim 1, wherein assuming that the image printing apparatus main body is to be manufactured as a commercial product without being connected to the accessory device, at least part of a filter to be provided to the image printing apparatus main body is built into the accessory device when the image printing apparatus main body is to be connected to the accessory device.

7. An image printing apparatus manufactured by a manufacturing method according to claim 1.

8. A method of manufacturing an accessory device for an image printing apparatus, comprising, in order to manufacture different types of accessory devices, the step of mounting a duct forming member which has at least one of a suction port and an exhaust port that are different in at least one of shape, position, and number to an accessory device main body which is common except for the duct forming member.

9. An accessory device for an image printing apparatus main body, which is manufactured by a manufacturing method according to claim 8.

10. An image printing apparatus, comprising:
an accessory device main body prepared to be in common among a plurality of types of image printing apparatuses; and
a duct forming member having at least either one of a suction port and an exhaust port and formed so as to specifically matches a specific type of image printing apparatus out of said plurality of types of image printing apparatuses regarding at least one of shape, position, and number;
wherein said specific type of image printing apparatus is manufactured by connecting an accessory device, which is formed by connecting the duct forming member to said accessory device main body, to said image printing apparatus main body.

11. The image printing apparatus of claim 10, wherein the duct forming member forms a side surface of the accessory device which opposes the image printing apparatus main body, and the image printing apparatus main body and the accessory device have a suction port and an exhaust port that communicate with each other.

12. The image printing apparatus of claim 10, wherein the image printing apparatus main body and the accessory device comprise blowing device.

13. The image printing apparatus of claim 10, wherein the accessory device comprises a casing portion which has at least either one of a suction port through which external air is introduced into the accessory device and an exhaust port through which air is exhausted outside from the accessory device.

14. The image printing apparatus of claim 13, wherein the casing portion is common among the plurality of types of image printing apparatus main bodies.
